(19) United States
(12) Patent Application Publication
(10) Pub. No.: US 2010/0068024 A1
(43) Pub. Date: Mar. 18, 2010

(54) REMOTELY CONTROLLED ROBOTS HAVING IMPROVED TOOL DEPLOYMENT SYSTEMS

(76) Inventor: Michael W. Agens, Columbia, NJ (US)

Correspondence Address: Doherty IP Law Group LLC, 37 Belvidere Ave, Washington, NJ, 07882, US

(21) Appl. No.: 12/212,789

(22) Filed: Sep. 18, 2008

(51) Int. Cl. B66C 3/00

(52) U.S. Cl. 414/729; 901/1; 901/30

(57) ABSTRACT

A remote controlled robot for handling hazardous material, such as explosive devices, includes a support frame, an articulating arm having a proximal end coupled with the support frame and a distal end remote therefrom, and a gripper connected with the distal end of the articulating arm, the gripper having gripper fingers that oppose one another. The robot includes a transporting assembly, such as wheels or a track, coupled with the support frame for selectively moving the robot to a desired location. The robot includes a tool basket disposed adjacent the proximal end of the articulating arm. The tool basket includes a plurality of tool receiving slots adapted to receive tools, with different tools stored in each of the slots. By carrying a plurality of tools in a basket, the robot may stay downrange when changing tools, rather than requiring the robot to return up range for changing tools.

### BACKGROUND OF THE INVENTION

1. Field of the Invention

The present invention generally relates to remotely controlled robots, and more specifically relates to remotely controlled robots used to detect, disable, and dispose of explosive devices, as well as vehicle entry, structure entry, surveillance, and barricaded subjects.

2. Description of the Related Art

Remote controlled robots are used by the military and public safety organizations to detect, defuse and dispose of hazardous materials such as explosive devices, and when addressing various hazardous incidents. Typically, these remote controlled robots include wheels or tracks that carry the robot to the site of a hazardous condition. Many of these remote controlled robots include an articulating arm with a gripper located at the distal end of the arm. The gripper includes opposing gripper fingers that move toward one another for closing the gripper and away from one another for opening the gripper.

Remotec, Inc. of Clinton, Tenn. sells a tool kit for remote controlled robots. The tool kit includes tools having different functions that are attached to rails extending along outer surfaces of gripper fingers. Because the tools are attached to the outside of the gripper fingers, the tools are not centered upon the gripper, which makes it more difficult to complete a hazardous material operation. In addition, the Remotec tools are attached to the gripper fingers using tightening knobs that secure the tools to the outer rails. As a result, the tooling attached to the gripper may not be changed when the robot is located downrange. Rather, the robot must be brought back up range in order to change the tools attached to the gripper, which wastes valuable time and resources.

Thus, there remains a need for remote controlled robot systems whereby the tools attached to the gripper may be changed as the robot remains downrange. Such a remote controlled robot system will be more efficient, and will be able to complete detection, defusing and disposal operations in a more efficient manner, saving time, lives, property and resources.

### SUMMARY OF THE INVENTION

In one embodiment, a remote controlled robot for handling hazardous material includes a support frame, an articulating arm having a proximal end coupled with the support frame and a distal end remote therefrom, and a gripper connected with the distal end of the articulating arm, the gripper having gripper fingers that oppose one another. The proximal end of the articulating arm is preferably connected with the support frame, and the articulating arm has arm sections interconnected by articulating joints that enable the arm sections to pivot relative to one another. The robot preferably includes a plurality of tools disposed adjacent the articulating arm, whereby the articulating arm is moveable for grasping the tools with the gripper. The robot desirably includes a transporting assembly coupled with the support frame for moving the robot over a surface.

In one embodiment, the robot includes a tool basket having a plurality of tool receiving slots, whereby each tool receiving slot is adapted to receive one of the tools. In one embodiment, the tool basket has a gripping structure such as a ring or flange that is secured to the basket and that may be grasped by the gripper for carrying the tool basket downrange. When the robot arrives downrange, the gripper can place the tool basket on the ground in close proximity to the robot so that the tools are accessible. The gripper is preferably moveable into alignment with each of the tool receiving slots so that the gripper may selectively secure and remove any one of the tools from the tool receiving slots. After the mission is completed, the gripper may pick up the tool basket by the gripping structure and return the tool basket to an up range location. In one embodiment, the tool basket may be permanently secured to the remote controlled robot such as by being secured to the support frame, which may be located adjacent the proximal end of the articulating arm.

The plurality of tools may include cutting tools, hook tools, illuminating tools, deflator tools, spiked tools, window breaker tools, and any other well known tool used to grasp, diffuse, and disable hazardous materials such as explosive devices.

In one embodiment, at least one of the tools includes a gripper block securable between the opposing gripper fingers, whereby the gripper block includes a leading end having a tool attachment opening, a trailing end, side walls extending between the leading and trailing ends, an upper securing flange extending laterally beyond the side walls, and a lower securing flange extending laterally beyond the side walls. The gripper fingers are preferably moveable toward one another for engaging the side walls of the gripper block so that the upper securing flange overlies top surfaces of the gripper fingers and the lower securing flange overlies bottom surfaces of the gripper flanges. In one embodiment, each of the tools is insertable into one of the tool attachment openings. In one embodiment, at least one of the tools is integrally attached to the gripper block and the working end of the tool projects from the leading end of the gripper block.

In one embodiment, each side wall of the gripper block has first and second sections that are angled relative to one another for defining an apex section of the side wall having a convexly curved surface, and the angled first and second sections of each side wall generally conform to an inner surface of one of the gripper fingers.

In one embodiment, a remote controlled robot for handling hazardous material includes a support frame, an articulating arm having a proximal end coupled with the support frame and a distal end remote therefrom, a gripper connected with the distal end of the articulating arm, the gripper having gripper fingers that oppose one another, a transporting assembly (e.g. wheels or tracks) coupled with the support frame for selectively moving the robot, and a tool basket coupled with the robot and disposed adjacent the proximal end of the articulating arm, the tool basket having a plurality of tool receiving slots adapted to receive tools.

The gripper is preferably moveable between a closed position for grasping the tools and an open position for releasing the tools. The articulating arm is desirably moveable for selecting and grasping a tool from one of the tool receiving slots.

In one embodiment, at least one of the tools includes a gripper block storable in one of the tool receiving slots, the gripper block having a leading end with a working end of each pool projecting from the leading end, a trailing end, side walls extending between the leading and trailing ends, an upper securing flange extending laterally beyond the side walls, and a lower securing flange extending laterally beyond the side walls. The gripper fingers are preferably moveable toward one another for engaging the side walls of the gripper block so that the upper securing flange engages top surfaces of the gripper fingers and the lower securing flange engages bottom surfaces of the gripper fingers. In one embodiment, each side wall of the gripper block has first and second sections that are angled relative to one another for defining an apex section of the side wall having a convexly curved surface, and the first and second angled sections generally conform to an inner surface of one of the gripper fingers.

In one embodiment, a remotely controlled robot for handling hazardous material includes a support frame, an articulating arm having a proximal end coupled with the support frame and a distal end remote therefrom, a gripper connected with the distal end of the articulating arm, the gripper having opposing gripper fingers moveable between an open position and a closed position, and a container holding a plurality of tools, whereby the container is disposed adjacent the articulating arm, and the articulating arm is moveable for aligning the gripper with one of the tools and grasping one of the tools using the grippers. The tools in the container may be any of the well-known tools used for handling hazardous materials (e.g. explosive devices) including cutting tools, hook tools, illuminating tools, deflator tools, spiked tools, and window breaker tools.

In one embodiment, the remote controlled robot is controlled wirelessly. In another embodiment, the remote controlled robot may be controlled through a tether such as a fiber optic cable or a power cable. In one embodiment, the robot may include a spool for storing the tether whereby the tether is unwound from the spool as the robot moves downrange and the spool is rewound as the robot returns up range.

Although the present invention is not limited by any particular theory of operation, it is well known to those skilled in the art that remote controlled robots may have an on-board battery supply having a limited operational life that requires frequent recharging. Thus, the present invention addresses this power issue by bringing a plurality of tools downrange in the tool basket. As a result, the robot does not have to return up range to change tools, which makes the robot more versatile and saves battery power so that the robot will be less likely to run out of battery power.

These and other preferred embodiments of the present invention will be described in more detail below.

### BRIEF DESCRIPTION OF THE DRAWING

FIG. 1 shows a perspective view of a remote controlled explosive ordinance disposal robot having a gripper.

FIG. 2 shows a perspective view of gripper fingers of the gripper shown in FIG. 1.

FIG. 3 shows a top plan view of the gripper shown in FIG. 1.

FIG. 4 shows a tool kit having various tools attachable to the gripper shown in FIG. 3.

FIG. 5A shows a perspective view of an illuminator tool attachable to the gripper shown in FIG. 3.

FIG. 5B shows the illuminator tool of FIG. 5A attached to one of the gripper fingers of the gripper shown in FIG. 3.

FIG. 6 shows a perspective view of a window breaker tool attachable to the gripper of FIG. 3.

FIG. 7 shows the remote controlled robot of FIG. 1 with tools attached to the gripper.

FIG. 8 shows a perspective view of a gripper block securable by a gripper of a remote controlled robot.

FIG. 9 shows a perspective view of tools securable to the gripper block of FIG. 8.

FIG. 10 shows the gripper block of FIG. 8 being held by the gripper of a remote controlled robot and a tool projecting from a leading end of the gripper block.

FIG. 11A shows a front elevational view of a gripper block, in accordance with one embodiment of the present invention.

FIG. 11B shows a top plan view of the gripper block shown in FIG. 11A.

FIG. 11C shows a side elevational view of the gripper block shown in FIGS. 11A and 11B.

FIG. 12 shows the gripper block of FIGS. 11A-11C held between opposing gripper fingers of a gripper and a tool secured to a front end of the gripper block, in accordance with one embodiment of the present invention.

FIGS. 13-15 show various tools that may be secured to a front end of the gripper block shown in FIGS. 11A-111C.

FIG. 16 shows a side view of a remote controlled robot including a tool basket for holding a plurality of tools, in accordance with one embodiment of the present invention.

FIG. 17A shows a top plan view of the tool basket shown in FIG. 16.

FIG. 17B shows a top plan view of the tool basket shown in FIG. 17A with a plurality of tools stored in some of the tool receiving slots of the tool basket.

FIG. 17C shows another top plan view of the tool basket having a plurality of tools shown in FIGS. 17A and B.

FIG. 18A shows the remote controlled robot of FIG. 16 positioned up range from an explosive device.

FIG. 18B shows the remote controlled robot of FIG. 18A after moving downrange toward the explosive device.

FIG. 18C shows the remote controlled robot of FIG. 18B with a different tool secured by the gripper.

### DETAILED DESCRIPTION

FIG. 1 shows a remote controlled robot 30 that is used for detecting, defusing, and disposing of explosive devices. The remote controlled robot 30 includes a platform 32 that supports equipment 34 and a plurality of wheels 36 for maneuvering the robot 30. A leading end of the platform 32 has an articulating arm 38 mounted thereon. The articulating arm 38 includes articulating joints 40 that enable the arm 38 to move in different directions for engaging objects. A distal end 42 of the articulating arm 38 includes a gripper 44 having a first gripper finger 46A and second gripper finger 46B that oppose one another. The gripper fingers 46A, 46B open and close toward one another for releasing and grasping objects.

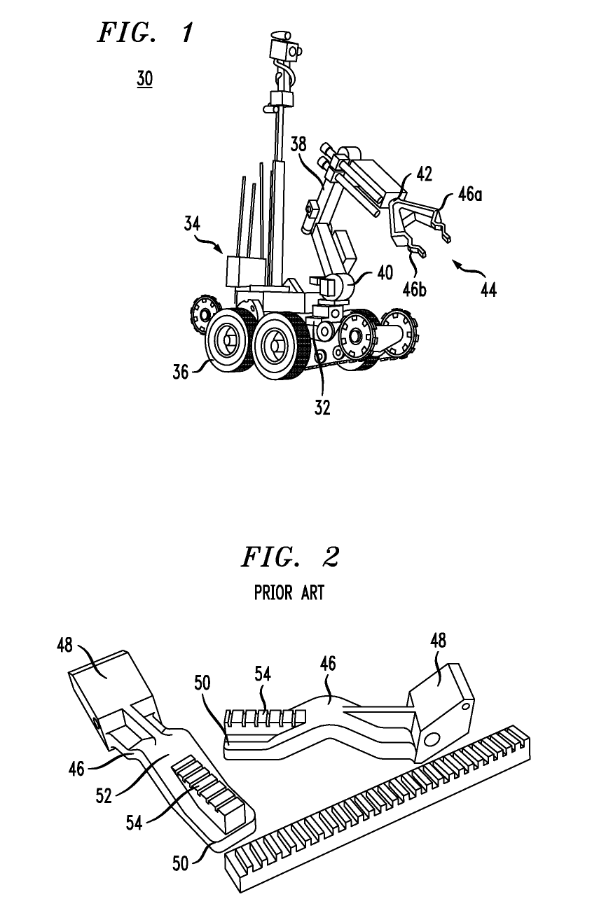

FIG. 2 shows a pair of gripper fingers 46 before being assembled to the distal end of an articulating arm of a remote controlled robot. The gripper fingers 46 has proximal ends 48 that are secured to the distal end of the articulating arm of the remote controlled robot (FIG. 1). Each gripper finger 46 includes a distal end 50 and an attachment rail 52 extending along an outer surface thereof for attaching tools to the gripper finger. The attachment rail 52 preferably extends to the distal end 50 of the gripper finger.

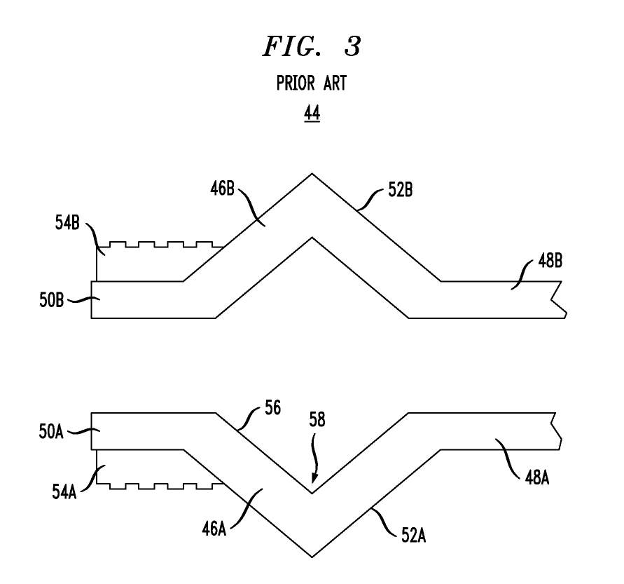

FIG. 3 shows a gripper 44 including the first gripper finger 46A and the second gripper finger 46B. The first gripper finger 46A has a proximal end 48A and a distal end 50A. The first gripper finger 46A has an outer surface 52A that extends between the proximal and distal ends 48, 50. A tool attachment rail 54A is secured to the outer surface 52A and extends to the distal end 50A of the first gripper finger 46A. The first gripper finger 46A includes an inner surface 56 that extends between the proximal end 48A and the distal end 50A of the first gripper finger. The inner surface 56 preferably has an angled surface defining a peak 58 therein. The second gripper finger 46B has s similar structure. The inner surfaces 56 of the gripper fingers may include a compliant layer such as a rubberized layer of material to improve gripping.

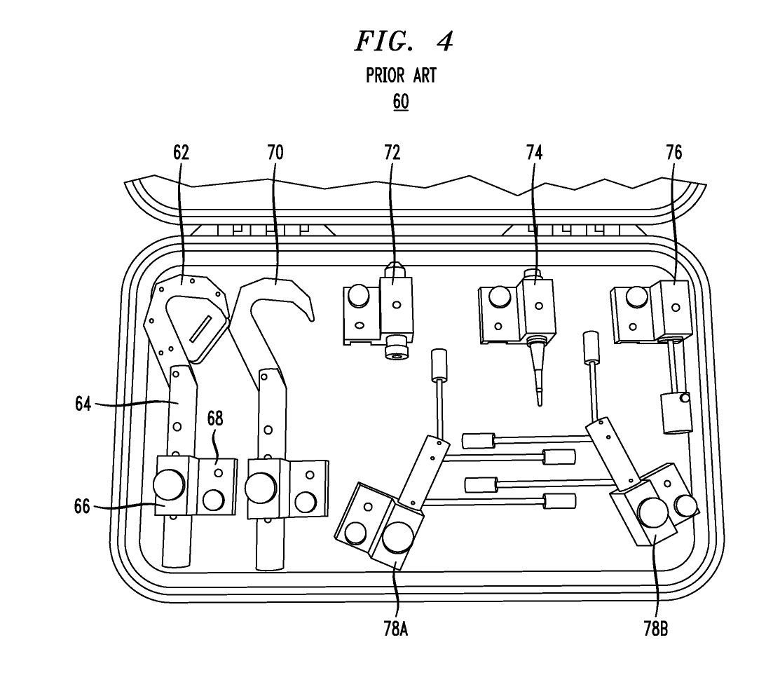

FIG. 4 shows a tool kit 60 including various tools adapted to be attached to the attachment rails 54 on the outer surfaces of the gripper fingers FIG. 3). The tool kit 60 includes a cutter 62 having a shaft 64 and a connector body 66 secured to the shaft 64. The connector body 66 includes an attachment flange 68 adapted to engage one of the attachment rails 54 (FIG. 3) for connecting the cutter tool 62 to the outside of one of the gripper fingers. The tool kit 60 also includes a hook tool 70, an illuminator tool 72, a window breaker tool 74, a deflator tool 76 and first and second probe tools 78A, 78B. All of the tools shown in FIG. 4 are securable to the gripper fingers shown and described above in FIGS. 2 and 3 by coupling the respective attachment flanges 68 with one of the attachment rails provided on the outer surface of each gripper finger.

FIG. 5A shows the illuminator tool 72 including connector body 66 having an attachment flange 68 projecting from a lower end thereof. The attachment flange 68 includes an outer surface 80 and an inner surface 82 having an elongated groove 84 formed therein. The elongated groove 84 is adapted to engage the attachment rails found on one of the gripper fingers for securing the illuminator tool 72 to one of the gripper fingers. The attachment flange 68 also includes a pair of openings 86A, 86B extending from the outer surface 80 to the inner surface 82. The illuminator tool 72 also includes a fastener 88 including a threaded shaft 90 and a tightening knob 92. When the illuminator tool 72 is positioned at a desired location along the length of the attachment rail, the fastener 82 may be tightened for securing the illuminator tool 72 in place at a preferred location along the length of the attachment rail.

FIG. 5B shows the illuminator tool 72 after being secured to the attachment rail 54 of the gripper finger 46. The fastener 88 (not shown) is tightened for reliably securing the illuminator tool 72 to the distal end 50 of the gripper finger 46. The illuminator tool 72 may be removed from its attachment to the attachment rail 54 by loosening the fastener 88 (FIG. 5A) and sliding the tool 72 of the distal end of the rail 54.

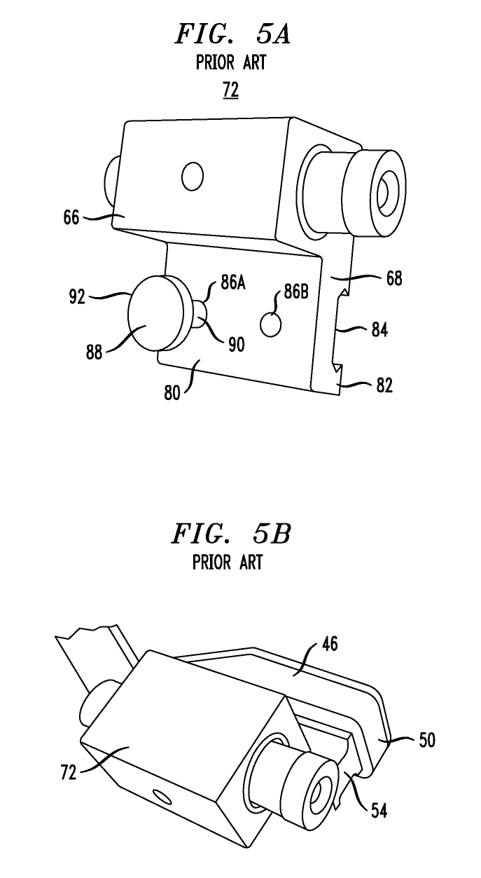

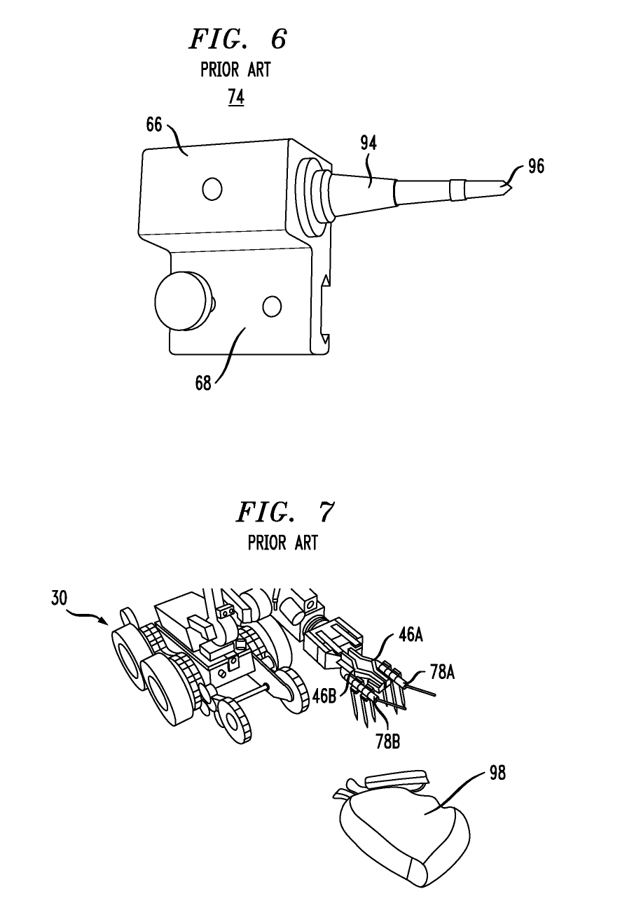

FIG. 6 shows the window breaker tool 74 having connector body 66 and the attachment flange 68 projecting from a lower end of the connector body. The window breaker tool 74 includes a tapered rod 94 projecting from a leading end of the connector body 66. The leading end of the tapered rod 94 has a point 96 that is adapted to be abutted against objects such as explosive devices.

FIG. 7 shows a perspective view of a remote controlled robot 30 having a first probe tool 78A secured to a first gripper finger 46A and a second probe tool 78B secured to a second gripper finger 46B. The remote controlled robot 30 is advanced downrange toward a suspicious object 98 (e.g. a back pack), so that the probe tools 78A, 78B may engage the suspicious object.

As shown in FIG. 7, the probe tools 78A, 78B are secured to the attachment rails located on the outside of the gripper fingers 46A, 46B. As a result, the probe tools 78A, 78B are not centered between the gripper fingers 46A, 46B, which may increase the difficulty of maneuvering the tools to efficiently inspect, handle and/or disable the suspicious object 98. This offset of the tools 78A-78B from the center of the gripper makes it more difficult for an operator to properly align the tools with the suspicious object and to efficiently handle emergency situations. This deficiency is particularly exacerbated for other tools such as the illuminator tool shown in FIGS. 5A-5B and the window breaking tool shown in FIG. 4. Thus, there is a need to provide an improved remote controlled robot whereby the tools may be centered directly between the gripper fingers for better alignment and better observation of suspicious objects.

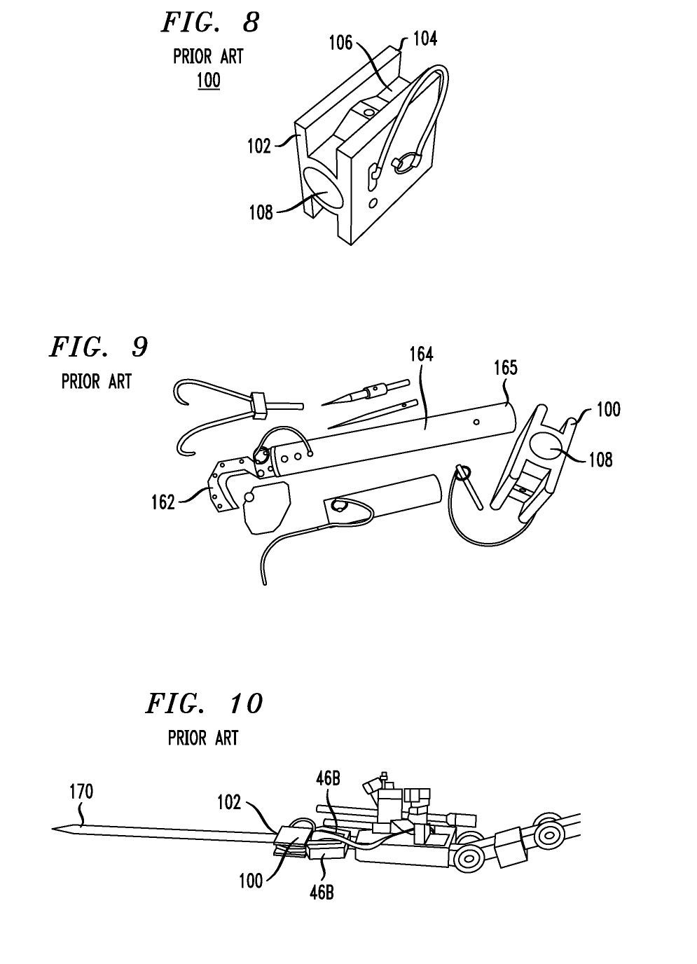

FIG. 8 shows a perspective view of a gripper block 100 used to hold various tools between gripper fingers. The gripper block 100 includes a leading end 102 and a trailing end 104. The gripper block 100 also includes sides 106 that extend between the leading and trailing ends thereof. The leading end 102 of the gripper block 100 includes a tool attachment opening 108 that is accessible at the leading end 102 of the gripper block and that extends from the leading end 102 toward the trailing end 104.

FIG. 9 shows various tools that may be inserted into the tool opening 108 of the gripper block 100. For example, a cutter tool 62 has a shaft 64 with a proximal end 65 insertable into the tool attachment opening 108. After the cutter tool 162 is secured to the gripper block 100, the gripper block 100 is secured between opposing gripper fingers for positioning the cutter tool 62 at the distal end of an articulating arm of a remote controlled robot.

FIG. 10 shows the gripper block 100 held between a pair of gripper fingers 46A, 46B. A probe 170 is inserted into the tool attachment opening 108 of the gripper block 100. The probe 170 projects from the leading end 102 of the gripper block 100. As shown in FIG. 10, positioning the gripper block 100 between the gripper fingers 46A, 46B enables the probe 170 to be centered between the gripper fingers. Centering the probe 170 facilitates handling of the probe tool 170 and efficient use during emergency situations.

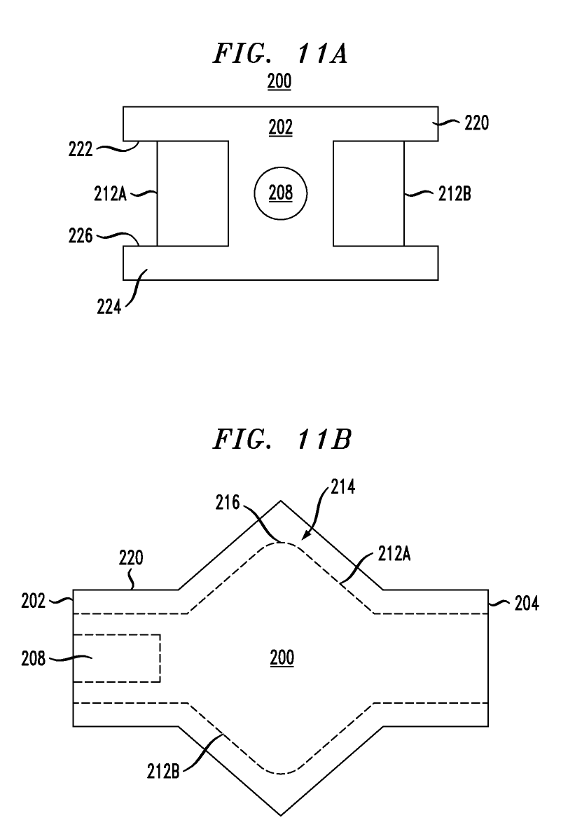

Referring to FIGS. 11A and 11B, in one embodiment, a gripper block 200 includes a leading end 202 and a trailing end 204. The gripper block 200 includes a pair of side walls 212A, 212B that extend between the leading and trailing ends thereof. The pair of side walls 212A, 212B define a central portion of the gripper block having a diamond shaped profile (FIG. 11B). Each of the side walls 212A, 2128B defines an apex 214 having a curved surface 216 defining a radius. The angled surface defined by the apexes 214 is generally adapted to conform to the shape of the inner surfaces of the gripper fingers. The curved surface 216 at the apex 214 is adapted to self-center the gripper block 200 between the opposing angled inner surfaces of the gripper fingers.

The gripper block 200 includes a tool attachment opening 208 that extend from the leading end 202 toward the trailing end 204 of the gripper block. The tool attachment opening 208 is adapted to receive a shaft of a tool used for handling and defusing explosive devices.

Referring to FIGS. 11A and 11B, the gripper block 200 includes an upper securing flange 220 having an inner surface 222 that projects outwardly and beyond the side walls 212A, 212B. The inner surface 222 of the upper flange 220 is adapted to engage the upper surfaces of respective first and second gripper fingers for snuggly securing the gripper block 200 to the upper surfaces of the gripper fingers.

Referring to FIG. 11B, the gripper block 200 includes a bottom securing flange 224 having an inner surface 226 that extends outwardly and beyond the side walls 212A, 212B. The bottom inner surface 226 is adapted to engage the bottom surfaces of the respective gripper fingers to snuggly secure the gripper block 200 to the lower surfaces of the gripper fingers.

FIG. 11C shows a side view of the gripper block shown in FIGS. 11A and 11B. The gripper block 200 includes the leading end 202 and the trailing end 204. The leading end 202 includes the tool attachment opening 208 adapted to receive the shafts of various tools. The gripper block 200 includes a side wall 212 having a central apex 214 with a curved surface 216 for seating the gripper block 200 against the angled inner surface of a gripper finger. The gripper block includes upper securing flange 220 having an upper inner surface 222 adapted to engage top surfaces of the gripper fingers and a lower securing flange 224 having a lower inner surface 226 adapted to engage the lower surface of the gripper fingers.

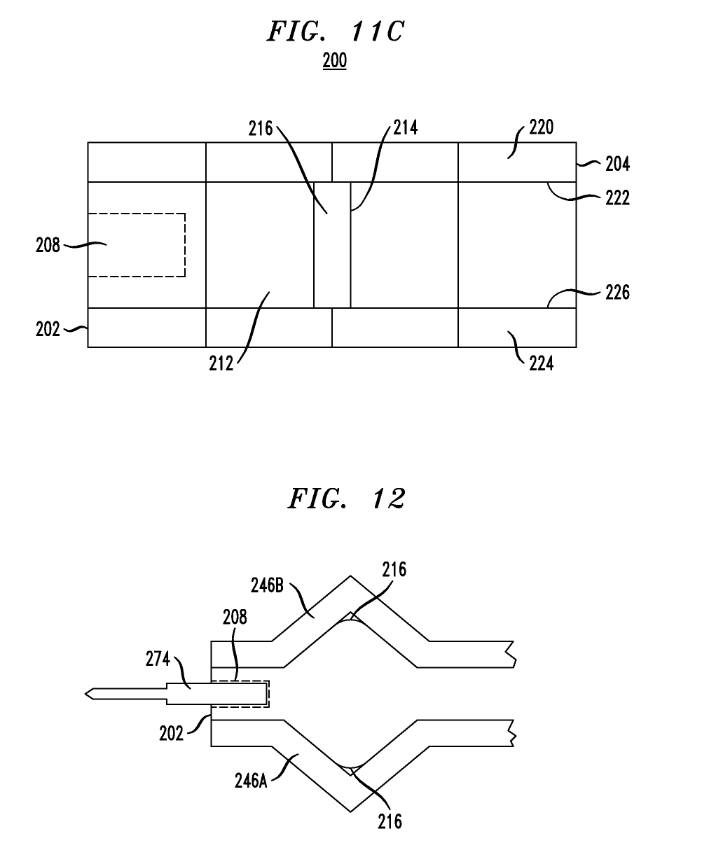

FIG. 12 shows the gripper block 200 of FIGS. 11-11C secured between a pair of gripper fingers 246A, 246B. The curved apexes 216 of the side walls of the gripper block 200 preferably self-center against the angled inner surfaces of the respective first and second gripper fingers 246A, 246B. In FIG. 12, the drawing has been simplified so that the securing flanges 220, 224 of FIG. 11C are not shown. Thus, the engagement between the inner surfaces of the gripper fingers and the side walls of the gripper block are clearly shown. As the gripper block 200 is held between the gripper fingers 246A, 246B, the tool 274 projects from the leading end 202 of the gripper blocks. In one embodiment, various tools may be inserted into and removed from the tool attachment opening 208. In other embodiments, different tools may be integrally connected with the leading end 202 of different gripper blocks 200. Thus, in one embodiment, a system may include a plurality of gripper blocks with each gripper block having a distinct tool integrally formed therewith and extending from a leading end thereof. Alternatively, the various tools may be inserted into and removed from the gripper blocks as needed. In one embodiment, the gripper blocks may have different sizes, whereby the size of the gripper block used may be associated with the particular tasks being performed.

Referring to FIGS. 13-15, in one embodiment, a tool system for a remote controlled robot includes a plurality of gripper blocks 300A-300C. Each gripper block has a shape and configuration generally similar to that shown and described above in FIGS. 11A-11C. In FIG. 13, a first gripper block 300A has a window breaking tool 374 projecting from a leading end thereof. The window breaking tool 374 may be integrally formed with the first gripper block 300A, or may be insertable into and removable from a tool attachment opening provided at the leading end 302 of the first gripper block 300A.

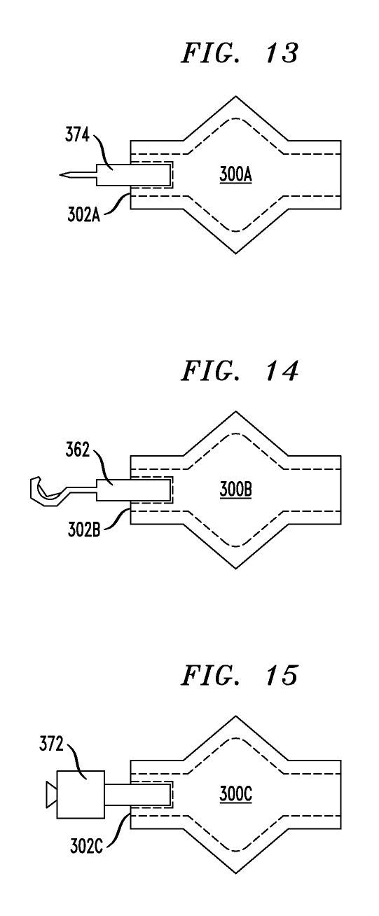

Referring to FIG. 14, a second gripper block 300B has a cutting tool 362 projecting from a leading end 302 thereof. The cutting tool 362 may be integrally formed with the second gripper block 300B. In one embodiment, the cutting tool 362 may be insertable into and removable from a tool attachment opening at the leading end 302 of the second gripper block 300B.

FIG. 15C shows a third gripper block 300C including an illuminating tool 372 secured to and projecting from a leading end 302 thereof. The illuminating tool 372 may be integrally formed with the third gripper block 300C. In one embodiment, the illuminating tool 372 may be insertable into and removable from a tool attachment opening provided at the leading 302 of the third gripper block 300C.

Although FIGS. 13-15 show gripper blocks having the same size and configuration, it is contemplated that one embodiment of the present invention may include gripper blocks having different sizes and/or configurations. The particular size of the gripper block utilized may be related to the particular function being performed when using the remote controlled robot. For example, if increased leverage is required when using the remote controlled robot, a gripper block having a larger size and/or dimension may be utilized to provide the additional leverage.

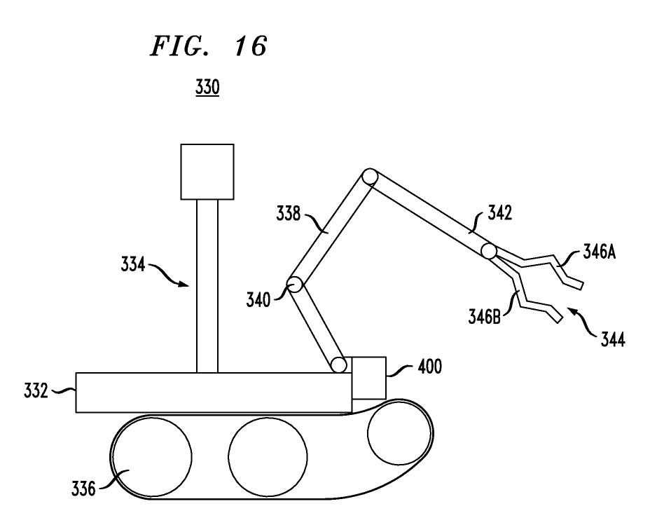

Referring to FIG. 16, in one embodiment, a remote controlled robot 330 includes a platform 332 that supports equipment 334 atop the platform 332. The remote controlled robot 330 includes wheels or tracks 336 for moving the robot 330 to desired locations. The remote controlled robot 300 includes an articulating arm 338 having articulating joints 340 that enable the articulating arm 338 to be configured and moved as needed for engaging objects. The distal end 342 of the articulating arm 338 includes a gripper 344 having a first gripper finger 346A and a second gripper finger 346B. The remote controlled robot 300 also includes a tool basket 400 adapted to hold a plurality of tools for use during operations. The tool basket is preferably positioned on the robot so that the tools stored therein may be grasped by the gripper of the articulating arm.

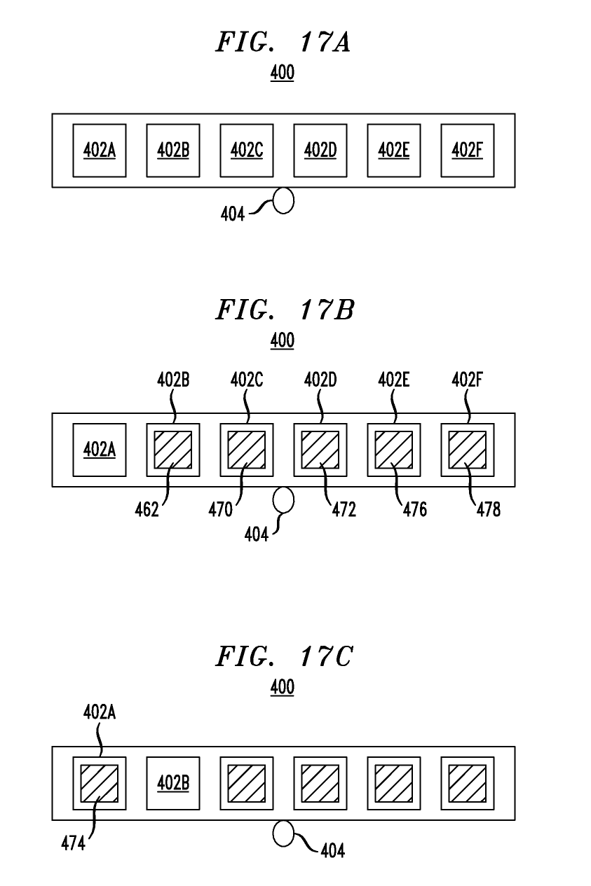

Referring to FIG. 17A, in one embodiment, the tool basket 400 secured to the remote controlled robot includes a plurality of tool receiving slots 402A-402F. In one embodiment, various tools are placed in each of the tool receiving slots 402A-402F before the remote controlled robot is sent downrange. As a result, a plurality of different tools is accessible by the gripper of the remote controlled robot as the robot remains downrange. Thus, the remote controlled robot does not have to return up range for changing tools as is required by conventional remote controlled robots. In one embodiment, the tool basket 400 includes a gripping structure 404 such as a ring or flange that may be grasped by the gripper. In one embodiment, the tool basket is not permanently attached to the robot and the tool basket is carried downrange by the gripper securing the gripping structure 404 and carrying the basket downrange. When the robot reaches a desired downrange location, the gripper may set the tool basket on a surface is close proximity to the robot and release the gripping feature 404 of the basket. The gripper and the articulating arm are then free to select one or more tools carried by the tool basket. When the mission is complete, the gripper may re-secure the tool basket using the gripping feature 404 and carry the tool basket back up range.

Referring to FIG. 17B, in one embodiment, the tool basket 400 is preloaded with a plurality of tools that perform different functions. As noted above, the tool basket is secured to the remote controlled robot so that the tools stored therein are accessible by the gripper provided at the distal end of the articulating arm. In FIG. 17B, the window breaking tool has been attached to the gripper. When downrange, the window breaking tool may be stored in the first tool receiving slot 402A. To improve the versatility of the remote controlled robot, a cutter tool 462 is preloaded in the second tool slot 402B, a hook 370 is preloaded in the third tool receiving slot 402C, an illuminator tool 372 is preloaded in the fourth tool receiving slot 402D, a deflator tool 376 is stored in the fifth tool receiving slot 402E, and a probe tool 378 is stored in the sixth tool receiving slot 402F.

Referring to FIG. 17C, if it is desirable to change one of the tools attached to the gripper when the robot is located downrange, the tool held between the gripper fingers such as the window breaker tool 474 is placed in the first tool slot 402A of the tool basket 400. A second tool such as the cutter tool 462 (FIG. 17B) may be grasped between the gripper fingers of the gripper and removed from the second tool slot 402B.

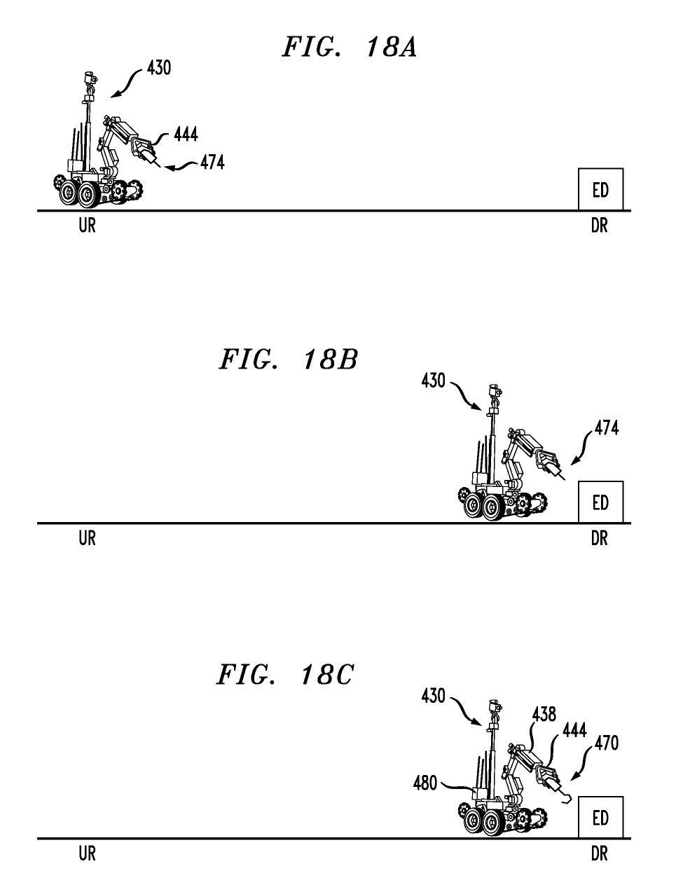

Referring to FIG. 18, in one embodiment, a remote controlled robot 430 is located up range “UR” from an explosive device “ED” found downrange “DR”. Before the robot is sent downrange DR a window breaking tool 474 is secured between the gripper fingers of the gripper 444.

Referring to FIG. 18B, after the window breaker tool 474 is secured between the gripper fingers, the remote controlled robot 430 is moved downrange DR so that it is adjacent the explosive device ED. During operation, an operator may determine that the window breaking tool 472 will not perform a desired function for disabling the explosive device ED. As a result, the operator will be required to change the tool held between the gripper 444. Referring to FIG. 18C, in one embodiment, the the operator preferably articulates the articulating arm 438 using a remotely-located controller to place the window breaker tool 474 in the tool basket and replace it with a hook tool 470. As the tool basket is either located in close proximity to the robot or secured to the remote controlled robot 430, the exchange of the tool may take place when the robot 430 is downrange DR. Thus, the remote controlled robot 430 does not have to return up range UR to change the tool, which saves battery power and minimizes the time required for performing an operation thereby reducing the danger level of the emergency situation.

Referring to FIG. 18C, in one embodiment, the remote controlled robot 430 includes a control system 480 having one or more microprocessors that are in communication with the articulating arm 438 and the gripper 444. The control system may have one or more tool loading and tool exchange routines programmed therein, whereby the control system automatically loads the tools onto the gripper. In one embodiment, an operator may select tool #1 and the control system will automatically take over operation of the articulating arm and the gripper for loading tool #1 onto the gripper. The operator may then choose to use another tool such as tool #4 and the control system will automatically return tool #1 to the correct slot in the tool basket and pick up tool #4 using the articulating arm and the gripper. Although the present invention is not limited by any particular theory of operation, it is believed that having a control system for automatically loading and exchanging tools when downrange will save time, will insure that the tools are properly loaded on the gripper, and will allow operators to concentrate on other tasks as the tools are being loaded/changed.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

While the foregoing is directed to embodiments of the present invention, other and further embodiments of the invention may be devised without departing from the basic scope thereof.

What is claimed is:

1. A remote controlled robot for handling hazardous material comprising:
a support frame;
an articulating arm having a proximal end coupled with said support frame and a distal end remote therefrom;
a gripper connected with the distal end of said articulating arm, said gripper having gripper fingers that oppose one another;
a plurality of tools disposed adjacent said articulating arm, wherein said articulating arm is moveable for grasping said tools with said gripper.

2. The robot as claimed in claim 1, further comprising a transporting assembly coupled with said support frame for moving said robot over a surface.

3. The robot as claimed in claim 1, wherein the proximal end of said articulating arm is connected with said support frame, and wherein said articulating arm comprises arm sections interconnected by articulating joints that enable said arm sections to pivot relative to one another.

4. The robot as claimed in claim 1, further comprising a tool basket having a plurality of tool receiving slots, wherein each said tool receiving slot is adapted to receive one of said tools.

5. The robot as claimed in claim 4, wherein said tool basket is secured to said support frame and located adjacent the proximal end of said articulating arm.

6. The robot as claimed in claim 4, wherein said gripper is moveable into alignment with each of said tool receiving slots so that said gripper may selectively secure and remove any one of said tools from said tool receiving slots.

7. The robot as claimed in claim 1, wherein at least one of said tools comprises a gripper block securable between said opposing gripper fingers, and wherein said gripper block includes a leading end having a tool attachment opening, a trailing end, side walls extending between the leading and trailing ends, an upper securing flange extending laterally beyond said side walls, and a lower securing flange extending laterally beyond said side walls.

8. The robot as claimed in claim 7, wherein said gripper fingers are moveable toward one another for engaging the side walls of said gripper block so that said upper securing flange overlies top surfaces of said gripper fingers and said lower securing flange overlies bottom surfaces of said gripper flanges.

9. The robot as claimed in claim 8, wherein each said side wall of said gripper block has first and second sections that are angled relative to one another for defining an apex section of said side wall having a convexly curved surface, and wherein the angled first and second sections of each said side wall generally conform to an inner surface of one of said gripper fingers.

10. The robot as claimed in claim 1, wherein said plurality of tools are selected from the group consisting of cutting tools, hook tools, illuminating tools, deflator tools, spiked tools, and window breaker tools.

11. The robot as claimed in claim 7, wherein each of said tools is integrally formed with one of said gripper blocks.

12. A remote controlled robot for handling hazardous material comprising:
a support frame;
an articulating arm having a proximal end coupled with said support frame and a distal end remote therefrom;
a gripper connected with the distal end of said articulating arm, said gripper having gripper fingers that oppose one another;
a transporting assembly coupled with said support frame for selectively moving said robot;
a tool basket coupled with said robot and having a plurality of tool receiving slots adapted to receive tools.

13. The robot as claimed in claim 12, wherein said tool basket includes a gripping structure provided thereon adapted to be secured by said gripper for selectively moving said tool basket to a desired location.

14. The robot as claimed in claim 12, wherein said gripper is moveable between a closed position for grasping said tools and an open position for releasing said tools.

15. The robot as claimed in claim 12, wherein said articulating arm of moveable for selecting and grasping a tool from one of said tool receiving slots.

16. The robot as claimed in claim 12, wherein at least one of said tools includes a gripper block storable in one of said tool receiving slots, said gripper block having a leading end with a working end of each said tool projecting from the leading end, a trailing end, side walls extending between the leading and trailing ends, an upper securing flange extending laterally beyond said side walls, and a lower securing flange extending laterally beyond said side walls.

17. The robot as claimed in claim 16, wherein said gripper fingers are moveable toward one another for engaging the side walls of said gripper block so that said upper securing flange engages top surfaces of said gripper fingers and said lower securing flange engages bottom surfaces of said gripper fingers.

18. The robot as claimed in claim 17, wherein each side wall of said gripper block has first and second sections that are angled relative to one another for defining an apex section of said side wall having a convexly curved surface, and wherein the first and second angled sections generally conform to an inner surface of one of said gripper fingers.

19. A remotely controlled robot for handling hazardous material comprising:
a support frame;
an articulating arm having a proximal end coupled with said support frame and a distal end remote therefrom;
a gripper connected with the distal end of said articulating arm, said gripper having opposing gripper fingers moveable between an open position and a closed position;
a container holding a plurality of tools, wherein said container is disposed adjacent said articulating arm, and wherein said articulating arm is moveable for aligning said gripper with one of said tools and grasping the one of said tools using said grippers.

20. The robot as claimed in claim 19, wherein said tools are selected from the group consisting of cutting tools, hook tools, illuminating tools, deflator tools, spiked tools, and window breaker tools.
